(19) United States
(12) Patent Application Publication
(10) Pub. No.: US 2010/0210159 A1
(43) Pub. Date: Aug. 19, 2010

(54) FIBER STRUCTURE AND METHOD OF MAKING SAME

(75) Inventor: Bizhong Zhu, Midland, MI (US)

Correspondence Address: REISING ETHINGTON P.C., P O BOX 4390, TROY, MI, 48099-4390, US

(73) Assignee: Dow Coming Corporation, Midland, MI (US)

(21) Appl. No.: 12/670,749

(22) PCT Filed: Jul. 24, 2008
(86) PCT No.: PCT/US08/71064

§ 371 Date: Jan. 26, 2010

Related U.S. Application Data
(60) Provisional application No. 60/952,363, filed on Jul. 27, 2007.

(51) Int. Cl. D03D 25/00; B32B 37/15; D02G 3/36

(52) U.S. Cl. 442/59; 156/167; 428/375; 428/392; 977/762

(57) ABSTRACT

A fiber structure and method of making the same are provided. The fiber structure comprises a microfiber structure having a nanofiber thereon. The nanofiber is formed by electrospinning a precursor solution to form a precursor nanofiber. The electrospun precursor nanofiber is deposited on the microfiber structure and fused therewith. In one preferable embodiment, silica nanofibers are formed on and fused with a glass microfiber.

### CROSS-REFERENCE TO RELATED APPLICATION

The instant application claims priority to U.S. Provisional Application Ser. No. 60/952,363 filed 27 Jul. 2007, the entire specification of which is expressly incorporated herein.

### FIELD OF THE INVENTION

The present invention relates to a fiber structure comprising microfibers and nanofibers and method for making the same.

### BACKGROUND OF THE INVENTION

Fibers are currently used as reinforcements for metal, ceramic or polymer compositions. These fibers can comprise virtually any composition. Common fibers include, but are not limited to glass fibers of various compositions such as E glass and S glass; organic polymer fibers such as aramid, polyester, polyolefin, nylon, polysulfone, and polyimide; metallic fibers such as stainless steel, steel, aluminum, silicon, and alloys of various compositions; ceramic fibers such as silicon carbide, silicon nitride, aluminum nitride, and metal oxides; and other inorganic fibers such as carbon and boron.

Typical fibers used for reinforcements are manufactured having a diameter in the micrometer range and are referred to herein as microfibers. Often the microfibers are woven although they can be non woven in use. Continuous microfibers, whether woven or non-woven, are useful for adding strength and modulus. However, property anisotropy, stress concentration and local non uniformity remain challenges when using microfibers to reinforce a matrix material. These problems sometimes present themselves as relatively facile localized fracture in the matrix they are imbedded in, leading to poor device efficiency when the composite is used as a part of a device, or premature failure when the composite is used for an application requiring one or a combination of load bearing, gas/liquid sealing, and electric/thermal insulating properties.

### SUMMARY OF THE INVENTION

According to one embodiment of the present invention, there is provided a method of forming a fiber structure comprising obtaining a microfiber structure and forming a nanofiber on the microfiber structure.

According to another embodiment of the present invention, there is provided a fiber structure. The fiber structure comprises a microfiber structure. The microfiber structure has a nanofiber thereon.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is flow diagram generally showing the method for reinforcing a fiber structure;

FIG. 2 is a scanning electron microscope photograph showing an electrospun nanofiber precursor on a microfiber structure, magnified 250 times;

FIG. 3 is a scanning electron microscope photograph of an electrospun nanofiber precursor on a microfiber structure, magnified 10,000 times on a glass fabric;

FIG. 4 is a scanning electron microscope photograph of an electrospun nanofiber on a microfiber structure, magnified 20,000 times;

FIG. 5 is a scanning electron microscope photograph of an electrospun nanofiber on a microfiber structure, magnified 250 times; and

FIG. 6 is a scanning electron microscope photograph of an electrospun nanofiber on a microfiber structure, magnified 1,000 times.

FIG. 7 is a schematic diagram illustrating one method for electrospinning a nanofiber.

### DETAILED DESCRIPTION OF THE PREFERRED EMBODIMENTS

The following description of the preferred embodiment(s) is merely exemplary in nature and is in no way intended to limit the invention, its application, or uses.

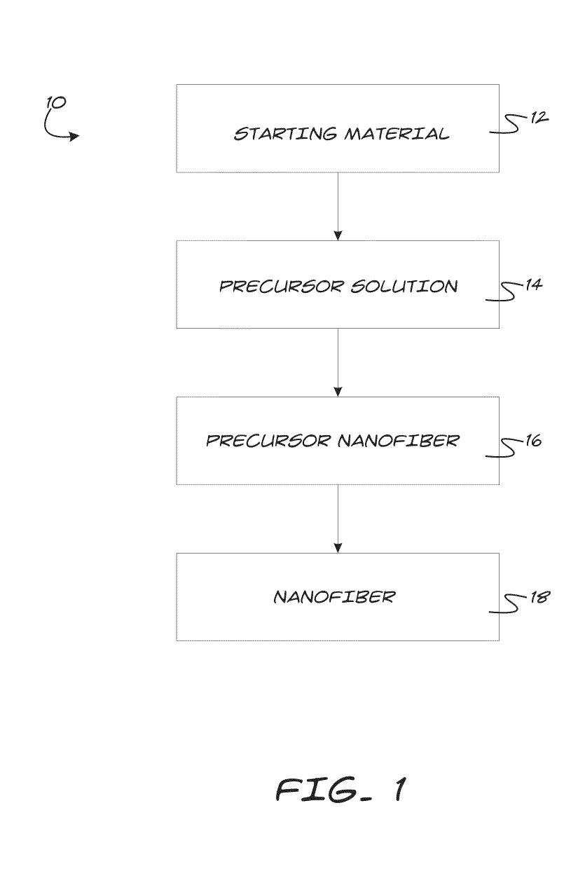

According to one embodiment of the present invention, there is provided a fiber structure comprising nanofibers on a microfiber structure. An embodiment of a method for making such a fiber structure generally comprises obtaining a microfiber structure and forming a nanofiber on the fiber structure. As shown in the FIG. 1, the method is generally indicated by the flow diagram at 10. Starting materials are mixed at 12. The starting materials are then heated to form a precursor solution at 14. The precursor solution is then converted to a precursor nanofiber at 16. The precursor nanofiber is then formed into a nanofiber at 18.

One embodiment of the present invention is useful for forming silica nanofibers onto a microfiber structure and will be specifically described herein. The microfiber structure can be any well-known type of fiber structure comprised primarily of fibers having diameters of micrometers. As is well-known, the microfiber structures are commonly used as reinforcements for many metal, ceramic or polymer composites. The microfiber structure can be woven or non-woven in use. Similarly, the microfibers can be continuous or non-continuous. The microfiber structure can be randomly oriented. It will be appreciated that while most of the fibers in the microfiber structure have diameters in the micrometer range, some of the individual fibers in the microfiber structure may not be in the micrometer range. However, it is preferred that the average diameter of the fibers be in the micrometer range.

As set forth above, the fibers of the microfiber structure can comprise any suitable woven or non-woven fiber structure that is primarily made of fibers having an average in the size of micrometers. By way of non-limiting example, suitable fibers may include glass fibers of various compositions such as E glass and S glass; organic polymer fibers such as aramid, polyester, polyolefin, nylon, polysulfone, and polyimide; metallic fibers such as stainless steel, steel, aluminum, silicon, and alloys of various compositions; ceramic fibers such as silicon carbide, silicon nitride, aluminum nitride, and metal oxides; and other inorganic fibers such as carbon and boron.

According to one embodiment of the present invention, a nanofiber is formed and is placed on, and preferably secured to the microfiber structure. The nanofiber can comprise any suitable material which can be made into a fiber having an average size in the nanometers. By way of non-limiting example, the nanofibers can be polymers, for example, polystyrene, PVP, polyimide, polyester, polyacrylonitrile, polyamide, polysilsesquioxane, silicone, PVC, PVDC, PTFE, polyacrylate, polyester, polysulfone, polyolefin, polyurethane, polysilsesquioxane, silicone, epoxy, cyanate ester, BMI, polyketone, polyether, polyamine, polyphosphazene, polysulfide, organic/inorganic hybrid polymer; inorganic oxides such as silicon dioxide, zinc oxide, aluminum oxide, tin oxide, lead oxide, titanium dioxide, magnesium oxides, calcium oxides, sodium oxides, potassium oxides, lithium oxides, indium oxides, manganese oxides, copper oxides, cobalt oxides, iron oxides, cerium oxides, antimony oxides, boron oxides, beryllium oxides, zirconium oxides, and mixed metal oxides; ceramics such as silicon oxycarbide, silicon oxynitride; or metal. By placing a nanofiber on the microfiber, a hybrid fiber reinforcement structure is provided that includes both microfibers and nanofibers.

The use of nanofibers compliments the micrometer sized fibers in size, orientation, fiber density and distribution. The use of nanofibers also allows for freedom to introduce added functionality depending on the choice of the fiber composition and morphology. Thus, the nanofiber can be chosen to optimize the properties of the fiber reinforcement, including but not limited to, the mechanical properties, electrical properties, magnetic properties, and thermal transformation properties of the fiber structure. In one embodiment, the nanofiber may be placed in the low fiber density area of the fiber structure.

By way of non-limiting example, one suitable nanofiber comprises a silica nanofiber to be placed on a glass microfiber structure. An example of the preparation of a silica nanofiber is set forth in the following description and shown in the Scanning Electron Microscope (SEM) photographs of FIGS. 2-6.

To prepare a silica nanofiber according to the example, 16.23 g of methyltrimethoxysilane (MTMS) was added into a three-neck round bottom flask equipped with a mechanical stirrer, thermometer, condenser, and a Dean Stark trap. 120 g of 1-butanol and 7 g of de-ionized water were added while stirring. The 1-butanol and de-ionized water are solvents. Subsequently, 0.03 g of trifluromethane sulfonic acid was then added. The trifluromethane sulfonic acid acts as a catalyst. The mixture was stirred without heating or cooling for 30 minutes. The temperature of this mixture was then raised to 70° C. and kept at 70° C. for an hour. The temperature was further raised to collect volatized components under the condenser. A final temperature of 120° C. was reached. At that point, the solid content of the residual solution in the flask was monitored. Heating was turned off once a concentration of approximately 8 weight percent of the solids was reached. This step produced an intermediate prepolymer solution.

15 g of the pre-polymer intermediate solution was then mixed with 0.5 g of polyvinyl pyrrolidone (PVP). This mixture was shaken continuously on a wrist-action shaker until the PVP was completely dissolved to form a precursor solution. The PVP was added to increase the viscosity to allow for electrospinning of the nanofiber precursor solution 14. The room temperature viscosity of the nanofiber precursor solution was approximately 100 centipoise.

This nanofiber precursor solution 14 was then formed into a precursor nanofiber 16. The precursor nanofiber 16 was prepared as follows. One embodiment for electrospinning the precursor nanofiber is shown schematically in FIG. 7. The precursor solution is placed in reservoir 20 which comprised a plastic syringe mounted on a syringe pump 22. The syringe pump 22 was coupled with a POPER® pipeting stainless steel needle 24 with a blunted end. The needle had a tip outer diameter of 0.05 in., inner diameter of 0.033 in., and a length of 2 in. A flat stainless steel electrode 26 was placed underneath the syringe needle, 9 cm from the needle tip. The electrode 26 was rectangular in shape and was 3 in.×4 in. in size. The electrode 26 was level and the needle was perpendicular to the flat electrode surface.

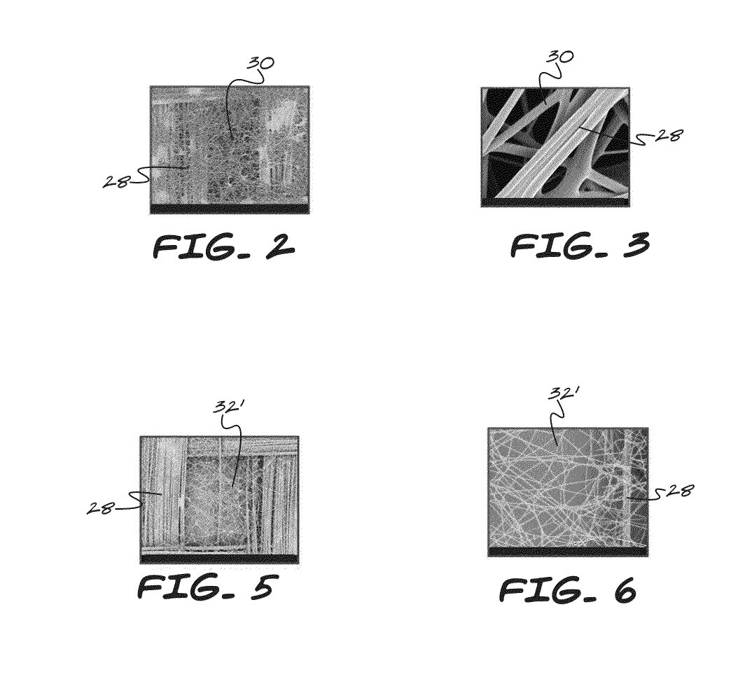

Style 106 glass fabric 28 purchased from BGF Industries was used as the microfiber structure. The glass fabric 28 was cut into rectangular shape and size which was slightly larger (not shown) than the flat stainless steel electrode 26. The microfiber structure is a woven structure from glass fibers having an approximate diameter of 6 micrometers. The glass fabric 28 piece was placed on the flat electrode 26. A direct current voltage of 13.3 kV was applied across the needle and the flat electrode with the needle being the cathode and the electrode 26 being the anode. As soon as the voltage was applied, the syringe pump 22 was started. The pumping speed was 5 ml/hr. Precursor nanofibers 30 were spun out of the needle tip and collected on the glass fabric 28 directly above the anode. The anode 36 with the glass fabric 28 was moved under the needle to distribute the precursor nanofiber 30 in a uniform manner. A total of 50 seconds of spinning time was used. The glass fabric 28 with the precursor nanofiber 30 was then dried. FIGS. 2 and 3 show the SEM photographs of the dried precursor nanofibers 30 on the glass fabric 28 at different magnifications. FIG. 2 has a magnification level of 250 times and FIG. 3 has a magnification level of 10,000 times. The precursor nanofibers ranged from 190 nm to 1200 nm in diameter and the average diameter was 610 nm.

The precursor nanofibers 30 were subsequently converted to silica nanofibers 32 at step 18 (FIG. 1) and fused to the glass fabric 28. More specifically, the glass fabric 28 having the precursor nanofiber 30 (as shown in FIGS. 2 and 3) thereon was placed in an air circulating furnace and heated. The temperature was raised 5° C. per minute to 575° C. Then, the temperature was held at 575° C. for 5 hours. The heat source was switched off and the furnace was allowed to cool. An SEM photograph of the heat treated fiber is shown in FIG. 4. As shown in FIG. 4, both the micrometer sized glass fiber 28 and the converted nanometer sized silica fiber 32 retained their shape. The average diameter of the converted silica nanofiber 32 after heating was 490 nm. This represents a decrease from the average of 610 nm of the precursor fiber. The representative nanofibers can have a typical diameter from 0.5 nm to 10,000 nm. The converted silica nanofiber 32 was fused to the woven glass fabric 28.

It will be appreciated, that one specific example has been provided herein to form one specific type of nanofiber that can be used in accordance with the present invention. One skilled in the art will readily understand that the starting material described herein can comprise any starting material that can be used to make a nanofiber. By way of non-limiting example, other starting materials may include, zinc acetate or AlCl, Zinc Octoate, Titanium tetrabutoxide, and their hydrolyzates at varying stage of condensation.

Similarly, any suitable solvent, catalyst or rheology modifying agent may be used within the context of the present invention to form a nanofiber. Thus, any other suitable solvent may be used instead of or in addition to 1-butanol. Other solvents may include but not limited to ethanol. Methanol, isopropanol, methyl isobutyl ketone, acetone, toluene, Xylene, hexane, heptane, ethyl lactate, ethyl acetate, diethyl ether, etc. The use of other solvents may affect the volatility of the solution, and may affect the fiber morphology and size.

Further, any other suitable rheology modifier can be used instead of or in addition to PVP. For example PVA can be also used. Additionally, the rheology modifier can be adjusted in concentration to change the rheology of the precursor solution. The rheology is controlled to provide a precursor solution that can be electrospun.

The processing parameters of the nanofiber precursor can also be adjusted. By way of non-limiting example, the pumping speed and the spin time can be adjusted. Similarly, distance between the needle (cathode) and the anode can be adjusted. The voltage across the anode and the cathode can also be adjusted. It will be appreciated that any processing parameters can be changed in order to optimize the size, orientation or properties of the nanofibers.

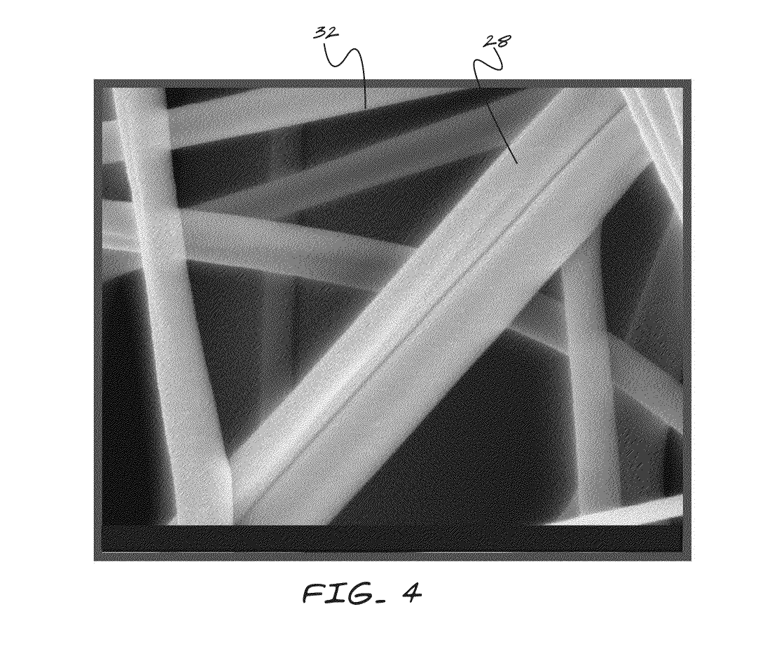

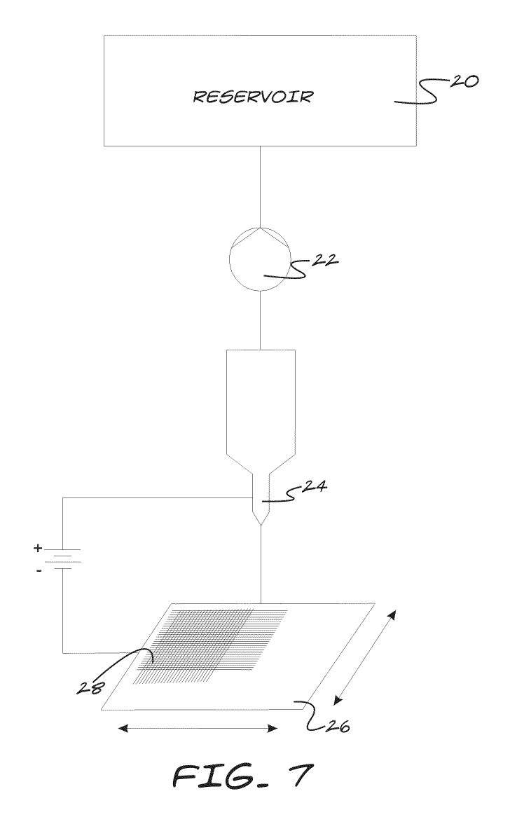

One example of a change in process parameters is illustrated in the following example. The precursor solution was prepared as set forth above. The process is the same as that set forth above, except that the total time used to spin the precursor nanofiber was reduced from 50 seconds to 25 seconds in an attempt to reduce the nanofiber density. FIGS. 5 and 6 shows the SEM photographs of the hybrid fiber network at different magnification levels after converting the precursor nanofiber into a silica nanofiber 32′ at 575° C. for 5 hours. As can be seen, the nanofiber density was reduced as compared with the examples shown in FIG. 4 above. The converted silica nanofibers were also well fused onto the glass microfiber and spanned the interstitial space between the glass fibers.

As set forth above, the microfiber structure is placed on an anode and the nanofiber is electrospun onto the fiber structure. It is preferred that the anode be moveable in at least two planes (in the direction of the arrangement shown in FIG. 7) during the electrospinning process. In this manner, the anode and, thereby, the microfiber structure can be moved to selectively orient and/or distribute the nanofiber on the microfiber structure. This allows control of the placement of the nanofibers. Movement of the anode can be achieved by use of a suitable controller (not shown). As a result, the final fiber structure provided comprised of microfibers and nanofibers can be engineered to optimize the mechanical properties and other properties of the final fiber network. By way of non-limiting example, the nanofiber may be placed in the low fiber density area of the fiber structure.

In the example set forth above, the nanofiber is created by electrospinning. In the example, the nanofiber is continuous. It will be appreciated, however, that within the scope of the present invention any suitable method for making the nanofiber is contemplated. Further, the nanofiber need not be continuous. Further, while in the example, the nanofiber is deposited on the microfiber structure, it will be appreciated that the nanofiber can be alternatively, or additionally deposited under the microfiber or interleave with the microfiber within the scope of the present claims.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of forming a fiber structure comprising:
obtaining a fiber structure; and
forming a nanofiber on the fiber structure.

2. A method as set forth in claim 1 wherein the step of forming the nanofiber comprises preparing a nanofiber precursor solution, forming a precursor nanofiber and heating the precursor nanofiber to form the nanofiber.

3. A method as set forth in claim 2 wherein the step of forming a precursor nanofiber comprises electrospinning the nanofiber precursor solution onto the fiber structure.

4. A method as set forth in claim 2 wherein the step of preparing a nanofiber precursor comprises mixing methyltrimethoxysilane with a solvent and a catalyst and heating the mixture to form a prepolymer intermediate solution.

5. A method as set forth in claim 4 wherein the solvent comprises 1-butanol.

6. A method as set forth in claim 4 wherein the catalyst comprises trifluromethane sulfonic acid.

7. A method as set forth in claim 4 wherein the mixture is heated in stages to a first temperature that is above ambient temperature and to a second temperature that is above the first temperature.

8. A method as set forth in claim 4 wherein the precursor intermediate solution is mixed with poly vinyl pyrrolidone to thereby form the nanofiber precursor solution.

9. A method as set forth in claim 3 wherein the step of electrospinning comprises positioning an electrode beneath a tip of a syringe needle and spaced therefrom, placing the fiber structure on the electrode, applying a voltage across the needle and the electrode and pumping the precursor solution through the needle tip to thereby form a precursor nanofiber on the fiber structure.

10. A method as set forth in claim 9 further comprising moving the electrode while forming the precursor nanofiber to control the application of the precursor nanofiber on the fiber structure.

11. A method as set forth in claim 9 further comprising heating the microfiber having the precursor nanofiber thereon to form the nanofiber and to fuse the nanofiber with the fiber structure.

12. A method as set forth in claim 1 wherein the fiber structure comprises a substantially microfiber structure.

13. A method as set forth in claim 1 wherein the fiber structure is a woven fiber.

14. A method as set forth in claim 1 wherein the nanofiber is continuous

15. A method as set forth in claim 1 wherein the nanofiber is randomly oriented.

16. A method as set forth in claim 1 wherein the nanofiber is placed in the low fiber density area of the fiber structure.

17. A fiber structure comprising:
a microfiber structure;
a nanofiber disposed on said microfiber structure.

18. A fiber structure as set forth in claim 17 wherein said nanofiber consists essentially of polymers, inorganic oxides, ceramics, metals or combinations thereof;

19. A fiber structure as set forth in claim 18 wherein said polymeric nanofiber is comprised of polystyrene, PVP, polyamide, polyacrylonitrile, polyimide, PVA, PVC, PVDC, PTFE, polyacrylate, polyester, polysulfone, polyolefin, polyurethane, polysilsesquioxane, silicone, epoxy, cyanate ester, BMI, polyketone, polyether, polyamine, polyphosphazene, polysulfide, organic/inorganic hybrid polymer, or combinations thereof.

20. A fiber structure as set forth in claim 18 wherein said inorganic oxide nanofibers are comprised of silicon oxides, zinc oxides, aluminum oxides, tin oxides, lead oxides, titanium oxides, magnesium oxides, calcium oxides, sodium oxides, potassium oxides, lithium oxides, indium oxides, manganese oxides, copper oxides, cobalt oxides, iron oxides, cerium oxides, antimony oxides, boron oxides, beryllium oxides, zirconium oxides, or combinations thereof.

21. A fiber structure as set forth in claim 18 wherein said microfiber structure comprises an inorganic microfiber.

22. A fiber structure as set forth in claim 17 wherein said nanofiber is fused with said microfiber structure.

23. A fiber structure as set forth in claim 22 wherein said nanofiber is electrospun on said microfiber.

24. A fiber structure as set forth in claim 17 wherein the microfiber structure is a woven fiber.

25. A fiber structure as set forth in claim 17 wherein the nanofiber is continuous

26. A fiber structure as set forth in claim 17 wherein the nanofiber is randomly oriented.

27. A fiber structure as set forth in claim 17 wherein the nanofiber is placed in the low fiber density area of the fiber structure.
